(19) United States
(12) Patent Application Publication
(10) Pub. No.: US 2009/0272814 A1
(43) Pub. Date: Nov. 5, 2009

(54) Passive Transponder and an Item with a Passive Transponder

(75) Inventors: Magnus Granhed, Lidingo (SE); Karl-Gosta Forssen, Jarfalla (SE)

Correspondence Address: POTOMAC PATENT GROUP PLLC, P. O. BOX 270, FREDERICKSBURG, VA, 22404, US

(73) Assignee: RECCO SYSTEMS AB, Lidingo (SE)

(21) Appl. No.: 12/435,469

(22) Filed: May 5, 2009

Related U.S. Application Data
(60) Provisional application No. 61/050,339, filed on May 5, 2008.

(51) Int. Cl. G06K 19/00

(52) U.S. Cl. 235/492

(57) ABSTRACT

A passive transponder includes an antenna having two electrically conductive parts; a diode connected to the antenna; and a transmission line connected to the antenna and to the diode. The transmission line is adapted to match the impedance of the diode to an impedance of the antenna. The passive transponder, when hit by radio frequency (RF) power of a first frequency f₁, retransmits RF power of a harmonic frequency fₕ. Each electrically conductive part of the antenna includes a flexible conductive thread having a first end and a second end, and the diode is connected to a first end of the flexible conductive thread. An item, such as a fabric or adhesive label, includes at least one passive transponder.

This application claims the benefit of the filing date of U.S. Provisional Patent Application No. 61/050,339, which was filed on May 5, 2008, and which is incorporated here by reference.

### BACKGROUND

This invention relates to a passive transponder adapted to be embedded in fabrics. This invention also relates to an item, for example an absorbent fabric for medical purposes, provided with at least one passive transponder adapted to be attached to, embedded in, or integrated into the item.

Absorbent fabrics are normally used to stop internal bleeding, for instance during surgery in hospitals, and there is a potential risk that the absorbent fabrics are left inside a patient's body after surgery is completed, which may cause the patient to be sick, or even die, from this mistake. Thus, there is a need to determine if the absorbent fabrics have been removed after surgery, and preferably before the wound is closed by stitches.

A way to determine if the absorbent fabrics have been removed is to keep track of how many pieces of absorbent fabric have been put into the patient, and then count how many have been removed. This is very impractical and a solution that may verify that all have been removed is more desirable.

A solution to this problem is to use any type of transmitting antennas, such as disclosed in U.S. Patent Application Publications No. US 2006/0161225, by Sormann et al. and No. US 2005/0095197 by Tuszynski et al., embedded in absorbent fabrics, since it is easy to detect any absorbent fabric unintentionally left inside a human body after surgery. An article from “Threadless @ Virginia Tech” with the title “News and Notes for our Industrial partners” (Dec. 12, 2006) discloses patch antennas that can be embroidered into fabric with a conductive thread.

However, it is not desirable to embed transmitting antennas into an absorbent fabric intended to be used during surgical procedures. A passive component that does not emit any signals until the detection takes place is desirable.

Passive transponders that, when hit by RF power of a first frequency f₁, retransmit RF power of a second harmonic frequency f₂, are known from U.S. Pat. No. 6,456,228. However, these are large in size and less flexible than is needed in order to be able to attach them to an arbitrarily shaped surface or embed them into a fabric.

Therefore, there is a need to provide a new type of passive transponders.

### SUMMARY

An object of the present invention is to provide passive transponders that are smaller and more flexible than prior art passive transponders.

That object can be achieved by a passive transponder, comprising an antenna having two electrically conductive parts, a diode connected between the electrically conductive parts, and a transmission line connected to the antenna and to the diode. The transmission line is adapted to match the impedance of the diode to an impedance of the antenna. The passive transponder, when hit by RF power of a first frequency f₁, retransmits RF power of a harmonic frequency nf₁, where n=2, 3, 4 . . . . Each electrical conductive part of the antenna comprises at least one flexible, electrically conductive, thread.

Another object of the present invention is to provide an item having a surface, adapted to be secured to an article with an arbitrary shape, to which surface a passive transponder can be attached, or in which surface a passive transponder can be embedded.

That object can be achieved by an item provided with at least one passive transponder with deformable properties attached to, or embedded in, the surface.

An object of a preferred embodiment is to provide a fabric that can be detected by a detector when the fabric is immersed in an electrically conductive environment, such as a human body.

That object can be achieved by a fabric provided with at least one passive transponder embedded in or integrated into the fabric.

An advantage of the present invention is that the passive transponder does not include a power source and thus does not transmit RF power until a detector activates the passive transponder by transmitting RF power of the correct frequency.

Another advantage of the present invention is that RF power of a harmonic second frequency will be detected by the detector only if a passive transponder is present in the area under investigation.

A further advantage of the present invention is that the item (or fabric) can be handled in any way, e.g., by folding, crumpling up, etc., without jeopardizing the function of the passive transponder due to the flexible design.

Further objects and advantages will be apparent to a skilled person from this description and the drawings.

### BRIEF DESCRIPTION OF THE DRAWINGS

The several features, objects, and advantages of the invention will be understood by reading this description in conjunction with the drawings, in which:

FIG. 1 shows a first embodiment of a passive transponder according to the present invention;

FIG. 2 shows a second embodiment of a passive transponder according to the present invention;

FIG. 3 shows a third embodiment of a passive transponder according to the present invention;

FIG. 4 shows a first embodiment of an item according to the present invention with embedded passive transponders;

FIG. 5 shows a second embodiment of an item according to the present invention with integrated passive transponders; and

FIG. 6 shows a third embodiment of an item according to the present invention with passive transponders attached to its surface.

### DETAILED DESCRIPTION

Passive transponders preferably need to be adapted to a desired receiving frequency and a transmitting frequency, which normally is twice as high as the receiving frequency, but any harmonic frequency will be sufficient for the passive transponder to work properly. The procedure to adapt the passive transponders is described in U.S. Pat. No. 6,456,228, which is incorporated here by reference.

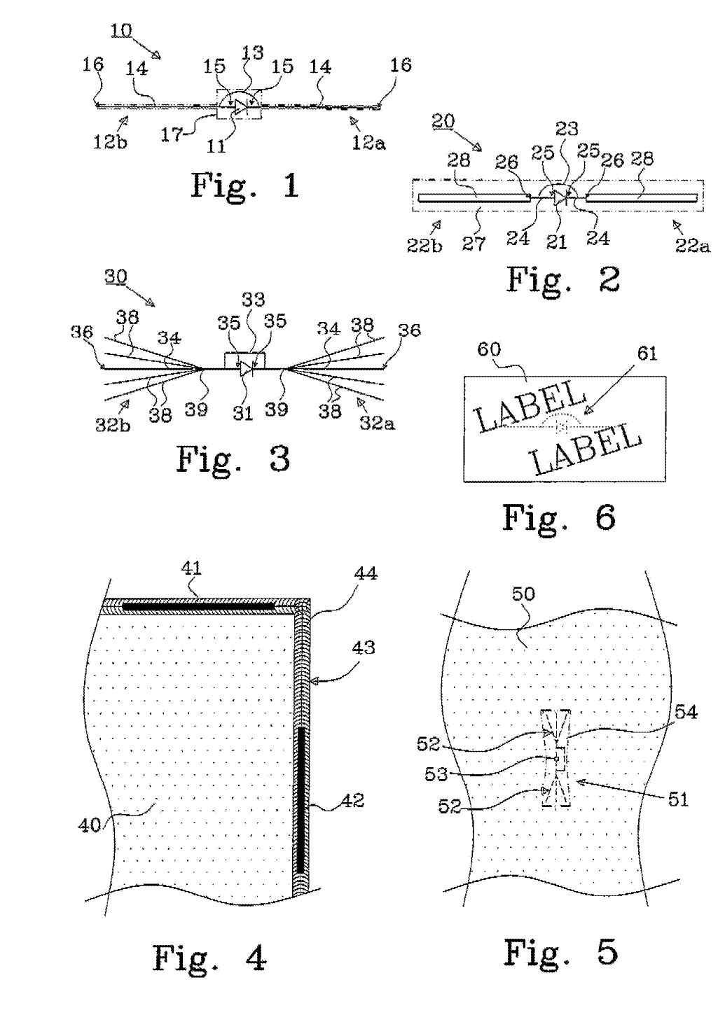

FIG. 1 shows a first embodiment of a passive transponder 10 comprising a diode 11, an antenna having two electrically conductive parts 12a and 12b, and a transmission line 13. Each electrically conductive part 12a, 12b of the antenna comprises in this embodiment an elongated thread 14 or wire having a first end 15 and a second end 16. The diode 11 is electrically connected between the first ends 15 of the elongated threads 14, and the transmission line 13, which is preferably implemented as a flexible thread, is adapted to match the impedance of the diode 11 to an impedance of the antenna by arranging the transmission line between the two electrically conductive parts 12a and 12b of the antenna. A dielectric cover 17 is preferably arranged around the antenna, transmission line 13, and diode 11, as indicated by the dash-dotted line in the figure, to increase the performance of the passive transponder.

FIG. 2 shows a second embodiment of a passive transponder 20, comprising a diode 21, an antenna having two conductive parts 22a, 22b, and a transmission line 23. Each electrically conductive part 22a, 22b of the antenna comprises in this embodiment a short thread 24 having a first end 25 and a second end 26, and a thin narrow foil strip 28 electrically connected to the second ends 26 of the threads 24. The diode 21 is electrically connected between the first ends 25 of the threads 24, and the transmission line 23, which is preferably implemented as a flexible thread, is adapted to match the impedance of the diode 21 to an impedance of the antenna by arranging the transmission line 23 between the two electrically conductive parts 22a, 22b of the antenna. A dielectric cover 27 is preferably arranged around the antenna, transmission line 23, and diode 21, as indicated by the dash-dotted line in the figure, to increase the performance of the passive transponder.

FIG. 3 shows a third embodiment of a passive transponder 30, comprising a diode 31, an antenna having two conductive parts 32a, 32b, and a transmission line 33. Each electrically conductive part 32a, 32b of the antenna comprises in this embodiment an elongated thread 34 having a first end 35 and a second end 36, and at least one additional thread, in this embodiment four additional threads 38, electrically connected to a point 39 on the elongated thread 34 situated between the first end 35 and the second end 36 of each thread 34. The diode 31 is electrically connected between the first ends 35 of the threads 34, and the transmission line 33, which is preferably implemented as a flexible thread, is adapted to match the impedance of the diode 31 to an impedance of the antenna by arranging the transmission line 33 between the two electrically conductive parts 32a, 32b of the antenna. A dielectric cover (not shown) can be arranged around the antenna, transmission line 33, and diode 31, as discussed in connection with FIG. 5.

A passive transponder may be as small as 1 mm×10 mm, but is preferably 2 mm×30 mm, and encapsulated in a material with a high dielectric constant, such as silicone. An important property of the passive transponder is that a piece of conducting material is attached to each side of a diode, and a transmission line is arranged between each side of the diode. The process of adapting the passive transponder to react to RF power of a desired frequency and to retransmit RF power of a harmonic frequency is readily apparent for a skilled person from the detailed description of U.S. Pat. No. 6,456,228.

The electrically conductive material of the antenna and the transmission line of the passive transponders is preferably a highly flexible material that can be folded without damaging the electrical properties of the material, e.g., insulated metal wires, or conductive threads as illustrated in connection with FIG. 5. It is naturally possible to replace the diode with any type of semiconductor component that has a PN junction, which will be appreciated by a person skilled in the art.

FIG. 4 shows a first embodiment of a fabric 40 having at least one passive transponder. In this embodiment, two passive transponders 41 and 42 are illustrated perpendicularly arranged to each other, embedded in the fabric 40. Any of the passive transponders described in connection with FIGS. 1-3 can be arranged at the edge 43, e.g., embedded in a hem or an edge seam 44 of the fabric 40. The passive transponders are preferably enclosed in a biocompatible material in order to prevent any unwanted materials in the passive transponder from coming in contact with fluids and human organs when the fabric is placed within a human body. Furthermore, the fabric is preferably absorbent, and is used to absorb human fluids, e.g., blood, during surgery.

FIG. 5 shows a second embodiment of a woven or non-woven fabric 50 having one passive transponder 51 integrated in the fabric by using conductive threads 52 as antenna and transmission line, which are illustrated by the dashed lines, electrically connected to each other and to a diode 53. When the fabric is intended for use inside a living body of a human or animal, it is desirable to enclose the passive transponder with a biocompatible, preferably flexible, material, such as silicone. Other suitable biocompatible materials will be apparent to a person skilled in the art. The biocompatible material is preferably arranged over the passive transponder 51 by applying a liquid gel. The gel will harden when exposed to air and form a cover, i.e., the passive transponder is coated with a flexible biocompatible material 54 that will prevent contact with the conductive components of the passive transponder.

It is of course possible to fasten a pre-manufactured passive transponder, such as illustrated in any of FIGS. 1-3, directly onto the fabric 50.

The fabric 50 may be formed into an arbitrary shape adapted for a product, e.g., a compress for absorbing fluids or a tamponade for flow stoppage of blood, used during medical treatment or surgery.

In order to be able to detect a piece of fabric, provided a passive transponder is attached to the fabric, radio frequency (RF) power of a first frequency f₁ needs to be transmitted from a detector. The transponder will then retransmit RF power of a harmonic frequency fₕ, i.e., a multiple of the first frequency f₁, where fₕ=nf₁, n=2, 3, 4, . . . . The retransmitted RF power of the harmonic frequency fₕ, preferably the second harmonic frequency f₂, is detected by the detector and the presence of the passive transponder is verified. If no RF power of the harmonic frequency is detected, there are no passive transponders present, and thus no fabric.

A detector, such as those commercially available from Recco AB, is preferably swept over an object, such as a living body of a patient, at a close distance to detect the presence of any passive transponders. The sweeping procedure is preferably performed prior to completion of the surgical operation, but it is also possible to verify the non-presence of passive transponders after the patient has left the operating room.

Although FIGS. 4 and 5 illustrate the use of the inventive passive transponder embedded in, or integrated in, a fabric, the invention is not limited to this.

FIG. 6 shows an item 60 having flexible properties, such as an adhesive label, or a sheet of plastic, that can be provided with a passive transponder 61 as described in connection with FIGS. 1-3. The passive transponders can be provided with an adhesive layer to facilitate adhesion to a non-adhesive surface of an item.

Item 60 is preferably a label (as illustrated in FIG. 6) provided with a passive transponder that can be attached to a larger article, such as a container with hazardous material. The surface of the article can have an arbitrary shape. The article can be detected by a detector and its location verified in order to prevent the article from being stored, or placed, in a non-permitted area, for example.

The artisan will understand that this invention can be embodied in many different forms, not all of which are described above, and all such forms are contemplated to be within the scope of the invention. The particular embodiments described above are merely illustrative and should not be considered restrictive in any way. The scope of the invention is determined by the following claims, and all variations and equivalents that fall within the range of the claims are intended to be embraced therein.

It is emphasized that the terms “comprises” and “comprising”, when used in this application, specify the presence of stated features, integers, steps, or components and do not preclude the presence or addition of one or more other features, integers, steps, components, or groups thereof.

What is claimed is:

1. A passive transponder, comprising:
an antenna having two electrically conductive parts, wherein each electrically conductive part of the antenna comprises a flexible conductive thread having a first end and a second end;
a diode electrically connected to a first end of the flexible conductive thread of the antenna; and
a transmission line connected to the antenna and to the diode, wherein the transmission line is adapted to match the impedance of the diode to an impedance of the antenna; and the passive transponder, when hit by radio frequency (RF) power of a first frequency f₁, retransmits RF power of a harmonic frequency fₕ.

2. The passive transponder of claim 1, wherein each electrically conductive part is provided with at least one thin flexible narrow foil strip electrically connected to the second end of the flexible conductive thread.

3. The passive transponder of claim 1, wherein each electrically conductive part is provided with at least one additional flexible conductive thread electrically connected to a point on the flexible conductive thread situated between the first end and the second end of the flexible conductive thread.

4. The passive transponder of claim 1, wherein the flexible conductive threads are insulated metal wires.

5. The passive transponder of claim 1, wherein the flexible conductive threads are configured to be integrated into a fabric.

6. The passive transponder of claim 5, wherein the transmission line is a conductive thread configured to be integrated into the fabric.

7. The passive transponder of claim 1, wherein the harmonic frequency fₕ is twice the first frequency f₁.

8. The passive transponder of claim 1, wherein the passive transponder is enclosed in a dielectric material to reduce an influence of surroundings of the passive transponder on a near field of the antenna.

9. The passive transponder of claim 8, wherein the dielectric material is a biocompatible material.

10. The passive transponder of claim 1, further comprising an adhesive layer.

11. An item including at least one passive transponder according to claim 1.

12. The item of claim 11, wherein the item is a flexible sheet of material, and the at least one passive transponder is attached to a surface of the flexible sheet of material.

13. The item of claim 11, wherein the item is an adhesive label.

14. The item of claim 11, wherein the item is a fabric.

15. The item of claim 14, wherein the fabric is absorbent and adapted to be used for absorbing fluids.

16. The item of claim 14, wherein the at least one passive transponder is embedded in the fabric.

17. The item of claim 16, wherein each passive transponder is arranged at an edge of the fabric.

18. The item of claim 14, wherein the at least one passive transponder is integrated in the fabric.

19. The item of claim 18, wherein the transmission line and the antenna of each passive transponder include conductive threads arranged within the fabric.

20. The item of claim 14, wherein the passive transponder is coated with a flexible biocompatible material.

21. The item of claim 14, wherein the fabric is formed into an arbitrary shape.

22. The item of claim 14, wherein the fabric is formed into a shape of a compress or a tamponade.
